(19) United States
(12) Patent Application Publication
(10) Pub. No.: US 2024/0006609 A1
(43) Pub. Date: Jan. 4, 2024

(54) INCREASING OLIVINE TYPE CATHODE GRAVIMETRIC ENERGY DENSITY BY INCREASING EXCHANGEABLE LITHIUM-ION CONTENT OR AVERAGE DISCHARGE VOLTAGE

(71) Applicant: Mitra Future Technologies, Inc., Mountain View, CA (US)

(72) Inventors: William Chueh, Menlo Park, CA (US); Chirranjeevi Gopal, San Francisco, CA (US); Kipil Lim, Mountain View, CA (US); Jordan Lampert, Cambria, CA (US)

(73) Assignee: Mitra Future Technologies, Inc., Mountain View, CA (US)

(21) Appl. No.: 18/217,286

(22) Filed: Jun. 30, 2023

Related U.S. Application Data
(60) Provisional application No. 63/357,439, filed on Jun. 30, 2022.

(51) Int. Cl. H01M 4/58

(52) U.S. Cl. CPC H01M 4/5825; H01M 2004/028

(57) ABSTRACT

The present technology discloses lithium metal polyanion (LMX) compounds. The battery cell including the LMX compounds as cathode may have a gravimetric capacity exceeding 170 mAh/g. The present technology utilizes machine learning to provide synthesis conditions and the stoichiometry of the LMX compounds to maximize the gravimetric energy density of a battery cell.

### CROSS-REFERENCE TO RELATED PATENT APPLICATION

This patent application claims the benefit under 35 U.S.C. § 119(e) of U.S. Patent Application Ser. No. 63/357,439, entitled “INCREASING GRAVIMETRIC ENERGY DENSITY FOR LITHIUM-METAL POLYANION BY INCREASING EXCHANGEABLE LI-ION CONTENT AND AVERAGE DISCHARGE VOLTAGE,” filed on Jun. 30, 2022, which is incorporated herein by reference in its entirety.

### TECHNICAL FIELD

The technology relates to generating increased gravimetric energy density (GED) compared to lithium iron phosphate (LFP) batteries, and more specifically, relates to increasing exchangeable Li-ion content and/or average discharge voltage from a combination of experiments and a machine-learning model.

### BACKGROUND

Lithium-ion batteries have been widely adopted as the most promising portable energy source in electronic devices because of their high working voltage, high energy density, and good cyclic performance. Lithium-ion batteries are used in electric vehicles and hybrid electric vehicles. In these lithium-ion batteries, olivine-type cathode materials such as LiMPO₄ (M=Fe and Mn) have attracted significant interest, especially due to their low cost and high intrinsic safety. However, they show poor electrochemical properties mainly due to their low electrical conductivities.

Lithium-Metal-Phosphates (LMP) where M=Mn have been extensively studied and described in the literature. LMP has been used as cathode materials for Li-ion batteries. This LMP cathode material has a nominal discharge voltage of 4.1 V, thus having a higher gravimetric energy density (GED) than lithium iron phosphate (LFP) by nominally 20%. However, LMP suffers from poor kinetics and lithium (Li) utilization because the orientation of the two-phase interface blocks the channel for Li-ion (Li+) diffusion. Composites of LMP and LFP have been described that increase the average nominal voltage, but these have not found widespread application.

Conventional LFP has limited gravimetric energy density (GED) due to its relatively low discharge voltage (nominally 3.45 V) and a moderate capacity (e.g., theoretical gravimetric capacity is 170 mAh/g while practical capacity ranges from 140 to 165 mAh/g).

There has been extensive work on LiMPO₄ or LiMSiO₄ compounds in which PO₄ or SiO₄ is the only anion, where M represents a transition metal or two or more transition metals. Very limited study is on the mixture of PO₄ anion and SiO₄ anion. For example, U.S. Pat. No. 5,910,382A discloses Li-ion cathodes including a mixture of PO₄ anion and SiO₄ anion. U.S. Pat. No. 6,136,472 also discloses a mixed Li-ion SiO₄ and PO₄ composition in the sodium superionic conductor (NASICON) structure and includes the composition LiₐM′_{(2-b)}M″_{b}Si_{c}P_{3-c}O₁₂. The mixture of PO₄ and SiO₄ has also been used as solid electrolytes for Na-ion batteries. The most well-known example crystallizes in the NASICON structure with the chemical formula Na₃Zr₂(PO₄)(SiO₄)₂.

Multi-modal distribution is a commonly employed technique to achieve higher green densities in ceramics. One common application is 3D printing. In binder jetting, the ability to achieve high green density is limited by the layer thickness of the powder, which may be overcome by mixing the powders including different particle sizes or different distributions of the particle sizes.

Batteries are an essential part of many devices from power tools to home power systems to electric and hybrid cars, among many other applications. Lithium iron phosphate (LFP) has been developed for power applications, such as power tools, starter batteries, and hybrid electric vehicles, among others. LFP's use in battery electronic vehicles (BEVs) is limited because of its low density. Batteries are a key technological pillar upon which many other technologies are built. Given the wide range of applications in which batteries are used, there is a similarly wide range of design requirements to develop battery cathode materials suitable for their applications. Unfortunately, the development of a new battery can be a time-consuming process, and expensive too.

Machine learning has shown promising results in a variety of applications. In the field of materials science, machine learning is used to develop new materials, optimize existing materials, and predict the properties of materials. One area of interest in the field of materials science is the synthesis of cathode materials for lithium-ion batteries. Lithium-ion batteries are used in many applications, including portable electronics, electric vehicles, and energy storage systems. The performance of these batteries is partially dependent on the cathode material used.

Lithium iron phosphate (LFP), nickel-cobalt-aluminum oxide (NCA), and nickel-cobalt-manganese oxide (NMC) are commonly used cathode materials in lithium-ion batteries. Synthesis of these cathode materials is a complex process involving various precursors and synthesis processing conditions. Modifying the precursors and synthesis processing conditions allow for the optimization of the properties of cathode materials. However, when optimizing the properties of cathode materials, it is challenging, expensive, and time-consuming to select precursors and the ratios of precursors and to control synthesis processing conditions.

Carbon coating is a commonly employed technique for improving the conductivity of cathode active materials in lithium-ion batteries. Carbon coating can improve the electrical conductivity of cathode active materials without changing other intrinsic properties. Uniform coating of carbon on LFP helps avoid charge congregation and unpreferable chemical reactions. Carbon coatings on cathode active materials or compounds, such as LFP, LMP, or lithium metal polyanion (LMX) compounds, may affect the cycling performance of the battery cells which contain carbon coated cathode powders.

It is desirable to have cathode materials with improved properties at reduced costs. However, development cycles for cathode materials with improved properties are very long. Therefore, there remains a need to develop methods to accelerate cathode material synthesis and battery cell production.

### BRIEF SUMMARY

The present technology utilizes machine learning to provide synthesis conditions and the stoichiometry of the lithium metal polyanion (LMX) compound represented in Formula (I) and Formula (II) to increase the gravimetric energy density of a battery cell.

In one aspect, a powder comprising a lithium metal polyanion (LMX) compound is represented by Formula (I):

Li(LiₓTM_{y}TM_{(1-x-y)})(P,A)O₄ Formula (I)

wherein 0.1≤x, 0≤y<1, and Li/(TM+TM′)>1, wherein TM is at least one element selected from Mn, Mg, Zn, Ca, Ni, Co, V, Al, Ti, Zr, Mo, Cr, or other transition metal. TM′ is a combination of Fe and Mn transition metal.

In some variations, at least one process variable or at least one stoichiometry variable to produce the compound represented in Formula (I) may be provided by a machine learning algorithm.

In some variations, TM is Mo, the compound is represented by Li[Li]_{0.2}Fe_{0.2}Mn_{0.5}Ti_{0.1}PO₄.

In some variations, TM is V, the compound is represented by Li[Li]_{0.1}Fe_{0.8}V_{0.1}PO₄.

In some variations, the compound is represented by Li[Li]_{0.1}Mn_{0.6}Mg_{0.2}V_{0.1}PO₄.

In another aspect, a method is provided for designing the LFP compound. The method may include optimizing the composition of the LFP compound to achieve the gravimetric capacity exceeding 170 mAh/g using a machine learning (ML) algorithm-assisted design combined with an experimental approach.

In some variations, the method may further include synthesizing the compound to form the powder. The method may also include evaluating the powder and the battery cell for electrochemical performance. The method may also include using the electrochemical performance and the powder information to train a Machine Learning (ML) model. The method may also include fitting a Gaussian process model using the energy density of the battery cell as output, subject to the constraints of powder level metrics falling within the set specs. The method may also include using the acquisition function to determine N variations to evaluate in the next iteration, which is likely to increase the energy density. The method may also include synthesizing the N variations. The method may also include evaluating the powder and the electrochemical performance of the battery cell, repeating the experiments, and training the ML model until the difference in successive iterations falls below a threshold.

In some variations, a cathode active material may include the LMX powder.

In some variations, a cathode may include the cathode active material.

In some variations, a battery cell may include the cathode, a separator, and an anode wherein the battery cell comprises a gravimetric capacity exceeding 170 mAh/g.

In a further aspect, a powder comprising a lithium manganese phosphate compound represented by Formula (II):

Li[Fe_{1-x-y}MnₓTM_{y}](P,A)O₄ Formula (II)

wherein 0.15<x<0.45, 0.20<y<0.45, wherein TM is at least one element selected from Mn, Mg, Zn, Ca, Ni, Co, V, Al, Ti, Zr, Mo, and Cr.

In some variations, the compound comprises Li[Fe_{0.4}Mn_{0.3}Mg_{0.3}]PO₄.

In some variations, the compound Li[Fe_{1-x-y}MnₓMg_{y}]PO₄ has the same structure as LiFePO₄ based on X-ray diffraction (XRD) analysis.

In some variations, A in Formula (I) and Formula (II) represents one of V, Si, or W.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a top-down view of a battery cell according to some aspects of the disclosed technology;

FIG. 2 illustrates a side view of a set of layers for a battery cell according to some aspects of the disclosed technology;

FIG. 3 is a workflow illustrating the steps for cathode synthesis and qualification at both powder and cell levels according to some aspects of the disclosed technology;

FIG. 4 illustrates X-ray diffraction (XRD) patterns of LiFePO₄ and Li[Fe_{0.4}Mn_{0.3}Mg_{0.3}]PO₄ compound according to some aspects of the disclosed technology;

FIG. 5 illustrates charging and discharging data of Li[Fe_{0.4}Mn_{0.3}Mg_{0.3}]PO₄ compound according to some aspects of the disclosed technology;

FIG. 6 illustrates comparisons of voltage versus capacity during charging or discharging for Li[Fe_{0.4}Mn_{0.3}Mg_{0.3}]PO₄, LiFe_{0.6}Mn_{0.4}PO₄, LiMnPO₄, and LiFePO₄ compounds according to some aspects of the disclosed technology;

FIG. 7 illustrates an example of a deep learning neural network that can be used to implement a perception module and/or one or more validation modules according to some aspects of the disclosed technology; and

FIG. 8 illustrates an example processor-based system with which some aspects of the disclosed technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details to provide a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

The disclosures of these patents, patent applications, and publications in their entireties are hereby incorporated by reference into this application to more fully describe the state of the art as known to those skilled therein as of the date of the invention described and claimed herein. The instant disclosure will govern in the instance that there is any inconsistency between the patents, patent applications, and publications and this disclosure.

Unless defined otherwise, all technical and scientific terms used herein have the same meaning as commonly understood by one of ordinary skill in the art to which this disclosure belongs. The initial definition provided for a group or term herein applies to that group or term throughout the present specification individually or as part of another group unless otherwise indicated.

Well-known features of Lithium-ion battery technology known to those skilled in the art have been omitted or simplified in order to not obscure the basic principles of the invention. Parts of the following description will be presented using terminology commonly employed by those skilled in the art.

i. Definitions

“Capacity” of a battery or battery cell is a measure of the charge stored by the battery and is determined by the mass of active material contained in the battery. The capacity represents the maximum amount of charge that can be extracted from the battery under certain specified conditions. The battery has a discharge current in amperes that can be delivered over time. The capacity of the battery is given in ampere-hours (Ah).

“Gravimetric capacity” is the capacity per unit mass (mAh/g). Gravimetric capacity is also referred to as specific capacity.

“Gravimetric energy density,” or specific energy, of a battery or battery cell is a measure of how much energy the battery contains in comparison to its weight and is typically expressed in Watt-hours/kilogram (W-hr/kg).

“Volumetric energy density” of a battery or battery cell is a measure of how much energy the battery contains in comparison to its volume and is typically expressed in Watt-hours/liter (W-hr/liters).

“Tap density” is a material property for a powder. The tap density of a powder is determined after defined tapping steps of the powder bed. More specifically, tap density considers pores and voids between particles, which are not based on a loose powder bed but a bed after a defined number of tapping steps. The tap density of a powder is a measure of the mass of the powder to the volume occupied by the powder after the defined tapping steps of the powder bed. The tap density is different from the bulk density of a powder, which can be determined if a powder is loosely poured into a measuring cylinder. The bulk density considers the pores and voids of a loose powder bed.

An oxidation-reduction (redox) reaction is a type of chemical reaction that involves a transfer of electrons between two species. An oxidation-reduction reaction is any chemical reaction in which the oxidation number of a molecule, atom, or ion change by gaining or losing an electron.

ii. Overview

The disclosed technology addresses the need in the art for increasing the gravimetric energy density (GED) of lithium-iron-phosphate (LFP) batteries. The GED of the LFP is limited by its relatively low discharge voltage (e.g., about 3.4 V) and moderate capacity (theoretical 170 mAh/g; practical 140 to 165 mAh/g). To be competitive with ternary cathode materials, it is useful to increase the GED. The GED of LFP is increased by changing the stoichiometry to add additional exchangeable Li and appropriately charge compensate the Li by substituting iron (Fe) with metals that allow higher oxidation states and/or partial substitution of phosphorus (P) in the anion PO₄ that lower the oxidation state of the phosphorus and makes the phosphorus redox-active.

The lithium (Li) content, nature, amount of doping at the Fe site, and synthesis conditions can be optimized using machine learning (ML) assisted design combined with an experimental approach, which is called active learning. The resulting Lithium Metal Polyanion (LMX) compounds from the ML-assisted design can have higher GED than the conventional LFP compounds by increasing their capacity and/or average discharge voltage.

The present technology includes an improved Fe-rich cathode that provides better performance to cost compared to conventional LFP and Ni-rich Nickel Manganese Cobalt (NMC) cathodes, as demonstrated in a performance (energy density Wh/liter) versus cost ($/kWh) curve. The disclosed iron-rich cathode design can achieve comparable peak performance as NMC622 and offer several advantages, including improved tap density, improved energy density by up to 20% through a combination of cation and poly-anion chemistry changes, and utilization of raw materials that are readily available through U.S. supply chains.

More specifically, the present technology substitutes Fe and the phosphate polyanion to enhance gravimetric energy density without compromising other metrics. LiFePO₄ allows extraction of one Li per formula unit. Orthosilicates (i.e., silicate anions SiO₄⁻⁴ and any of its salts and esters) are another class of cathodes. For example, Li₂MSiO₄ is an exemplary orthosilicate, where M represents one or more transition metals. These orthosilicates often have lower redox voltage but allow extraction of up to two Li per formula unit as M changes its oxidation state from 2⁺ to 3⁺ to 4⁺, which practically doubles the capacity of the material. However, the silicate systems suffer from poor cycle life as the crystal structure undergoes a variety of phase transitions as Li is intercalated in and out of the system.

The present technology also involves the simultaneous substitution of M for Fe and SiO₄ for PO₄, which taps into the higher theoretical energy density of the silicates and overcoming the short cycle-life limitation through the stabilizing effect of phosphate polyanions.

iii. Battery Cells

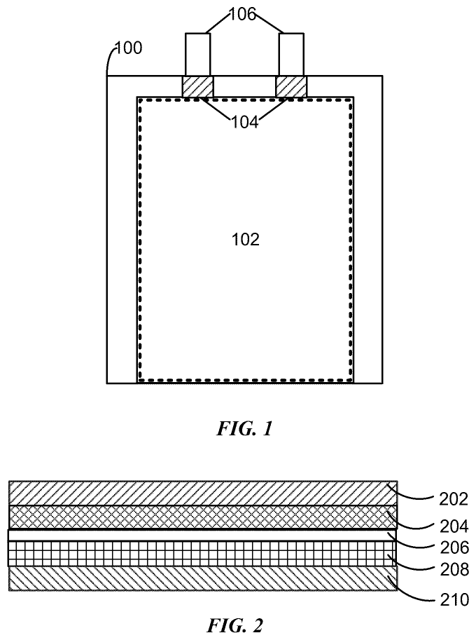

FIG. 1 illustrates a top-down view of a battery cell 100 according to some aspects of the disclosed technology. The battery cell 100 may correspond to a lithium-ion battery cell that is used to power a device used in a consumer, medical, aerospace, defense, and/or transportation application.

The battery cell 100 includes a stack 102 containing a number of layers that include a cathode with a cathode active material, a separator, and an anode with an anode active material. More specifically, stack 102 may include one strip of cathode active material (e.g., aluminum foil coated with a lithium compound) and one strip of anode active material (e.g., copper foil coated with carbon). Stack 102 also includes one strip of separator material (e.g., conducting polymer electrolyte) disposed between the one strip of cathode active material and the one strip of anode active material. The cathode, anode, and separator layers may be left flat in a planar configuration.

Enclosures can include, without limitations, pouches, such as flexible pouches, rigid containers, and the like. Returning to FIG. 1, during assembly of the battery cell 100, stack 102 is enclosed in an enclosure. Stack 102 may be in a planar or wound configuration, although other configurations are possible.

Stack 102 can also include a set of conductive tabs 106 coupled to the cathode and the anode. The conductive tabs 106 may extend through seals in the enclosure (for example, formed using sealing tape 104) to provide terminals for the battery cell 100. The conductive tabs 106 may then be used to electrically couple the battery cell 100 with one or more other battery cells to form a battery pack. The battery cell may be used for battery electric vehicles. In some variations, the battery cell 100 may be a coin cell.

Batteries can be combined in a battery pack in any configuration. For example, the battery pack may be formed by coupling the battery cells in a series, parallel, or series-and-parallel configuration. Such coupled cells may be enclosed in a hard case to complete the battery pack or may be embedded within an enclosure of a portable electronic device, such as a laptop computer, tablet computer, mobile phone, personal digital assistant (PDA), digital camera, and/or portable media player.

FIG. 2 presents a side view of a set of layers for a battery cell according to some aspects of the disclosed technology. The set of layers may include a cathode current collector 202, a cathode active material 204, a separator 206, an anode active material 208, and an anode current collector 210. The cathode current collector 202 and the cathode active material 204 may form a cathode for the battery cell, and the anode current collector 210 and the anode active material 208 may form an anode for the battery cell. To create the battery cell, the set of layers may be stacked in a planar configuration or stacked and then wrapped into a wound configuration.

As mentioned above, the cathode current collector 202 may be aluminum foil, the cathode active material 204 may be a lithium compound, the anode current collector 210 may be a copper foil, the anode active material 208 may be carbon, and the separator 206 may include a conducting polymer electrolyte.

iv. Lithium Metal Polyanion (LMX) Compounds

The present technology helps identify a stoichiometry of LMX compounds that increase the gravimetric energy density beyond that of conventional LFP. In various aspects, increasing lithium content may increase capacity, improve stability, and increase gravimetric energy density.

In some aspects, the stoichiometry of the LMX compounds includes those with Li/(Fe+TM)>1 (i.e., the ratio of Li to the sum of Fe and TM is higher than 1), and the charge compensates the additional Li by appropriate choice of transition metal's (TM's) and/or partial substitution of P in the anion PO₄ that lower its oxidation state and make it redox-active, where TM represents a substitutional cation dopant or dopants. This is different from the compounds in U.S. Pat. No. 9,178,215, which describes compounds with excess Li/(Fe+Mn+D) at a maximum of 1.05, and 0.35≤Mn≤0.60 and dopant D is 0.001≤D≤0.1. In other words, U.S. Pat. No. 9,178,215 describes a compound with a ratio of Li to the sum of Fe, Mn, and D to be at most 1.05, while the amount of Mn is within the range of 35-60% of metals, and the amount of the dopant is within the range of 0.1%-1.0%.

Multiple redox of Mn (e.g., Mn^{2+/3+} and Mn^{3+/4+}) can result in higher GED. More specifically, access to the wider range of oxidation states of Mn can provide additional electrons to result in higher GED. The present technology demonstrates that the doping of approximately 0.3 mol of Mg may help the utilization of Mn³⁺/Mn⁴⁺redox within the olivine-type cathode material. The compound does not need to have excess lithium.

In some aspects, the exchangeable Li⁺ content is increased by the addition of Li⁺ to the Fe²⁺sites. This is charge compensated by substituting some of the Fe²⁺with a higher oxidation state transition metal that is also capable of multiple higher oxidation states.

Li⁺ is added to a Fe site and the charge is compensated by lowering the average oxidation state of the anion, PO₄³⁻to (P, A)O₄^{(-3+x)}, generating a compound represented by Formula (A) as follows:

Li(LiₓTM′₍₁₋ₓ₎)(P,A)O₄ Formula (A)

In addition to Li, x amount more of Li⁺ is added to the transition metal site, such that the overall charge of Li, Liₓ, and TM′₁₋ₓ is charge balanced against the anion, where TM′ represent the combination of Fe and Mn. The anion (P, A)O₄ is redox-active due to the presence of A to allow for the exchange of the additional Li⁺, where A may be silicon (Si), vanadium (V), and tungsten (W), among others.

In some aspects, the compound can be generalized to include the substitution of Fe by other transition metals according to Formula (B):

Li(LiₓTMy TM′ (i_{—} z _y))(P, A)0 4 Formula (B)

where LiₓTM_{y}TM′_{(1-x-y)} are elements in the Fe²⁺ site of LiFePO₄, y represents the fraction of TM, x represents the fraction of excess Li, 0.1≤x, 0≤y<1, and Li/(TM′+TM)>1, The x, y, and z represent atomic percentages or mole fractions. wherein TM is one or more elements selected from Mn, Mg, Zn, Co, V, Al, Ti, Zr, Mo, Cr, or other transition metal, and TM′ represent the combination of Fe and Mn. The transition metal balances a charge during de-lithiation by oxidizing into a more positive oxidation state.

In one embodiment, x=0.2, y=0.1, M=Ti, and the Formula (B) becomes Li[Li]_{0.2}Fe_{0.2}Mn_{0.5}Ti_{0.1}PO₄, where [Li] designates a Li⁺ in a Fe²⁺ site of LiFePO₄-. Here, the titanium (Ti) is in +4 for the charge neutrality of the pristine material.

In another embodiment, x=0.1, y=0.1, M=Mo, and the Formula (B) becomes Li[Li]_{0.1}Fe_{0.8}Mo_{0.1}PO₄, where [Li] designates a Li⁺ in a Fe²⁺ site. Here, the molybdenum (Mo) is in the +3 oxidation state, and swings to +6 to utilize all of the Li⁺. The average voltage is also increased due to the higher voltage of Mo³⁺ to Mo⁶⁺.

In another embodiment, x=0.1, y=0.1, M=V, and the Formula (B) becomes Li[Li]_{0.1}Fe_{0.8}V_{0.1}PO₄, where [Li] designates a Li⁺ in an Fe²⁺ site, vanadium (V) is in the +3 oxidation state, and can swing to +5 to utilize all of the Li⁺. The average voltage of the compound is also increased due to higher voltage of V³⁺ to V⁵⁺.

In some aspects, a compound composition is represented by Formula (C) as follows:

Li[Li_{1-x-y-z}FeₓMn_{y}TM_{z}](P,A)O₄ Formula (C)

where x represents the fraction of Fe, y represents the fraction of Mn, z represents the fraction of TM to Li, 0≤x≤1, 0≤y≤0.8, 0<z≤0.6 , transition metal (TM) includes one or more of Mg, Zn, Co, V, Al, Ti, Zr, Mo, or Cr. In one embodiment, x=0, y=0.8, and z=0.2, and the formula (C) becomes Li[Mn_{0.8}Mg_{0.2}]PO₄. 0.8 of Mn can balance a charge during de-lithiation by oxidizing Mn²⁺ to Mn³⁺. Further (partial) oxidation of Mn³⁺ to Mn⁴⁺ utilizes the remaining 0.2 Li during de-lithiation.

In some variations, 0≤x≤1.0. In some variations, 0≤x≤0.9. In some variations, 0≤x≤0.8. In some variations, 0≤x≤0.7. In some variations, 0≤x≤0.6. In some variations, 0≤x≤0.5. In some variations, 0≤x≤0.4. In some variations, 0≤x≤0.3. In some variations, 0≤x≤0.2. In some variations, 0≤x≤0.1.

In some variations, 0≤y≤0.8. In some variations, 0≤y≤0.7. In some variations, 0≤y≤0.6. In some variations, 0≤y≤0.5. In some variations, 0≤y≤0.4. In some variations, 0≤y≤0.3. In some variations, 0≤y≤0.2. In some variations, 0≤y≤0.1.

In some variations, 0<z≤0.6. In some variations, 0<z≤0.5. In some variations, 0<z≤0.4. In some variations, 0<z≤0.3. In some variations, 0<z≤0.2. In some variations, 0<z≤0.1.

By combining the above Li[Mn_{0.8}Mg_{0.2}]PO₄ compound with additional Li and V, a cathode material having the formula Li[Li_{0.1}Mn_{0.6}Mg_{0.2}V_{0.1}]PO₄ can be synthesized. In other words, in relation to Formula (C), x=0, y=0.6, TM=Mg, V, and z=0.3 (i.e., the sum of the percentages of the transition metals Mg and V, 0.2+0.1).

v. Olivine-Type Cathode Material Without Excess Li

The present technology also provides improvements in GED without introducing excess Li. Excess lithium is often used to provide additional capacity. Thus, the removal of excess lithium results in lower energy capacity. However, the present technology addresses the limitations of the removal of excess lithium by leveraging additional transition metals. More specifically, olivine-type cathode materials can include LiMPO₄ (M=Fe and Mn). Utilizing Mn as a transition metal can provide additional capacity by using both of the Mn^{2+/3+} and Mn^{3+/4+} redox reactions.

In some aspects, multiple redox of Mn can be utilized in the olivine-type cathode material, such as Mn^{2+/3+} and Mn^{3+/4+} redox. Olivine-type cathode material is represented by Formula (D) as follows:

Li[Fe_{1-x-y}MnₓTM_{y}](P,A)O₄ Formula (D)

Where 0.15<x<0.45, 0.20<y<0.45, wherein TM is at least one element selected from Mn, Mg, Zn, Ca, Ni, Co, V, Al, Ti, Zr, Mo, Cr, among others, x represents the fraction of Mn, y represents the fraction of TM.

In some variations, 0.15<x<0.45. In some variations, 0.20<x<0.45. In some variations, 0.25<x<0.45. In some variations, 0.30<x<0.45. In some variations, 0.35<x<0.45. In some variations, 0.40<x<0.45. In some variations, 0.15<x<0.40. In some variations, 0.15<x<0.35. In some variations, 0.15<x<0.30.In some variations, 0.15<x<0.25. In some variations, 0.15<x<0.20.

In some variations, 0.25<x<0.35. In some variations, 0.20<x<0.35. In some variations, 0.20<x<0.30.In some variations, 0.15<x<0.30. In some variations, 0.15<x<0.25. In some variations, 0.10<x<0.35. In some variations, 0.10<x<0.30. In some variations, 0.10 <x<0.25. In some variations, 0.10<x<0.20. In some variations, 0.10<x<0.15.

In some variations, 0.20<y<0.45. In some variations, 0.20<y<0.40. In some variations, 0.20<y<0.35. In some variations, 0.20<y<0.30. In some variations, 0.20<y<0.25. In some variations, 0.25<y<0.45. In some variations, 0.30<y<0.45. In some variations, 0.35 <y<0.45. In some variations, 0.40<y<0.45.

In some variations, 0.25<y<0.35. In some variations, 0.20<y<0.35. In some variations, 0.20<y<0.30. In some variations, 0.15<y<0.30. In some variations, 0.15<y<0.25. In some variations, 0.10<y<0.35. In some variations, 0.10<y<0.30. In some variations, 0.10 <y<0.25. In some variations, 0.10<y<0.20. In some variations, 0.10<y<0.15.

Experiments demonstrated the successful synthesis of high gravimetric energy density (GED) olivine compounds represented by Formula (D).

In one embodiment, x=0.3 and y=0.3, TM=Mg, and the Formula (D) becomes Li[Fe_{0.4}Mn_{0.3}Mg_{0.3}]PO₄. The fraction of Mg is outside the conventional range 0.2>y>0.

This Li[Fe_{0.4}Mn_{0.3}Mg_{0.3}]PO₄ compound has been successfully synthesized. The synthesis utilizes Mn^{3+/4+} redox during charging and discharging. Mn^{3+/4+} has a higher redox voltage than Mn^{2+/3+} which has a redox voltage of about 4.1 V. Mn^{3+/4+} also has a higher redox voltage than Fe^{2+/3+} which has a redox voltage of about 3.45 V. Thus, access to Mn^{3+/4+} redox increases the GED and offsets the reduced capacity from the removal of excess lithium.

Additionally, doping the material with approximately 0.3 mol of Mg in the Li[Fe_{0.4}Mn_{0.3}Mg_{0.3}]PO₄ compound may help the utilization of Mn^{3+/4+} redox within the olivine-type cathode material. Additionally, the Li[Fe_{0.4}Mn_{0.3}Mg_{0.3}]PO₄ compound has demonstrated a similar XRD pattern to LiFePO₄ from X-ray diffraction (XRD) analysis.

vi. Machining Learning Assisted Optimization of LMX Cathode Active Material

There are thousands to tens of thousands of possible variations to test to achieve an optimal cathode and each variation is resource intensive, expensive, and time consuming to synthesize and test. For example, such variables to be adjusted in the design space include at least: (1) Li excess (x), (2) Nature of substitutional cation dopant (M), (3) Amount of M (y), (4) Nature of substitutional poly-anion dopant (A), (5) Amount of A (z), (6) Synthesis temperature T1, (7) Synthesis dwell time at temperature T1, (8) Synthesis temperature T2, (9) Synthesis dwell time at temperature T2.

In some variations, a higher amount of one or more doping elements, such as Mg or Zn among others, may be added to the compound to obtain high GED.

There is no analytical relation between the variables and the metrics of interest (such as electrochemical performance of the cathode, particle size, tap density, phase purity etc.), The goal is to determine a probable result as measured by the metrics of interest for a set of parameters for the variables.

Active learning refers to a class of machine learning models that guide efficient and parsimonious data collection to build a model that maps from inputs for the variables (design variables) to outputs as quantified by the metrics of interest. A specific implementation involves Bayesian optimization to trade-off exploration and exploitation strategies. The two components of a Bayesian optimization are 1) model function and 2) acquisition function.

For the model function, Gaussian Processes will be used because of their probabilistic basis and ability to encode physically-grounded kernels for the covariance function.

The goal of Bayesian optimization is to use a set of observations and suggest where to evaluate the experiment next. The acquisition function is typically an inexpensive function that can be evaluated at a given point that is commensurate with how desirable evaluating f at x is expected to be for the minimization problem. The acquisition function can be optimized to select the location of the next observation. It can also be interpreted as a loss function in the context of optimization problems. Typical choices of acquisition functions include the probability of improvement, expected improvement, upper confidence bound, among others. Certain acquisition functions, such as expected improvements, are better for research settings, where the goal of experimentation is to “explore” a design space, while “upper confidence bound” acquisition function is better suited for a global maximization (or minimization) as in a more development setting.

The acquisition function can be one of upper confidence bound, expected improvement, or information gain can be used. There is a trade-off between exploration and exploitation based on the intent of the experimental campaign (research vs development). Further, the optimization can be performed in a batch setting, implying that at each iteration, multiple data points can be collected in parallel, subject to constraints of available resources.

For example, a workflow for an experimental campaign to increase gravimetric energy density can be as follows:

Step 1: Synthesize N variations from the variables in the design space addressed above, and evaluate powder specs and coin cell electrochemical data. A variation is defined as a vector of values for the variables in the design space above. This serves as seed data to train the model.

Step 2: Fit a Gaussian Process model using coin cell energy density as the output, subject to the constraints of set specifications that the powder level metrics should fall within.

Step 3: Using the acquisition function, determine N variations [N can be varied] to evaluate in the next iteration, which is likely to or predicted to increase the energy density.

Step 4: Synthesize the N variations from step 3 and evaluate powder specs and coin cell electrochemical data.

Step 5: Repeat steps 2-4 until either the experimental budget is exhausted, the difference in successive iterations falls below a threshold, or an iteration satisfies a set of specifications for the target gravimetric energy density (GED).

Cathode development involves trade-offs. The algorithm can provide Pareto-optimal choices of design variables that increase gravimetric energy density without severely compromising rate capability, resistance, tap density, and other quantities. The algorithm can also work with noisy data and categorical variables.

The cathode developments are used to study a particular excess Li range to achieve the target gravimetric energy density (GED) by combining experiments with machine learning.

When excess Li is used to increase GED, other properties may become worse or may be compromised. Machine learning can help discover the appropriate tradeoffs. For example, machine learning predictions can help discover how life cycle, capacity, voltage, energy retention, stability, among others, will be affected. The optimization is multi-objective including increasing GED and trying not to compromise transport properties (conductivity, surface reaction kinetics, Li+diffusion rate, etc.), and cycle life, among other factors. The optimization will be Pareto-optimal and discover the trade-offs. All the other metrics can be measured as well and be used for informing experiments. For example, to maximize GED, constraints can include keeping the voltage less than 4.1 V, utilizing elements that are still abundant are used (e.g., to reduce material cost), while also having a goal of getting identical or improved transport properties.

Machine learning can help reduce the number of experiments to run in arriving at the target GED. There will be efficiency gain in terms of the number of experiments to run to achieve a set trade-off. Each set of experiments will be informed by the prior experiments and data. Compared to the traditional design of experiments, where the design is static (i.e., experiments to run are preset), Bayesian optimization and/or active learning approaches dynamically decide data collection and build a model of the response surface with every incremental data collection. This allows one to use the most updated information to decide the course of further experiments.

vii. Workflow For Cell Development

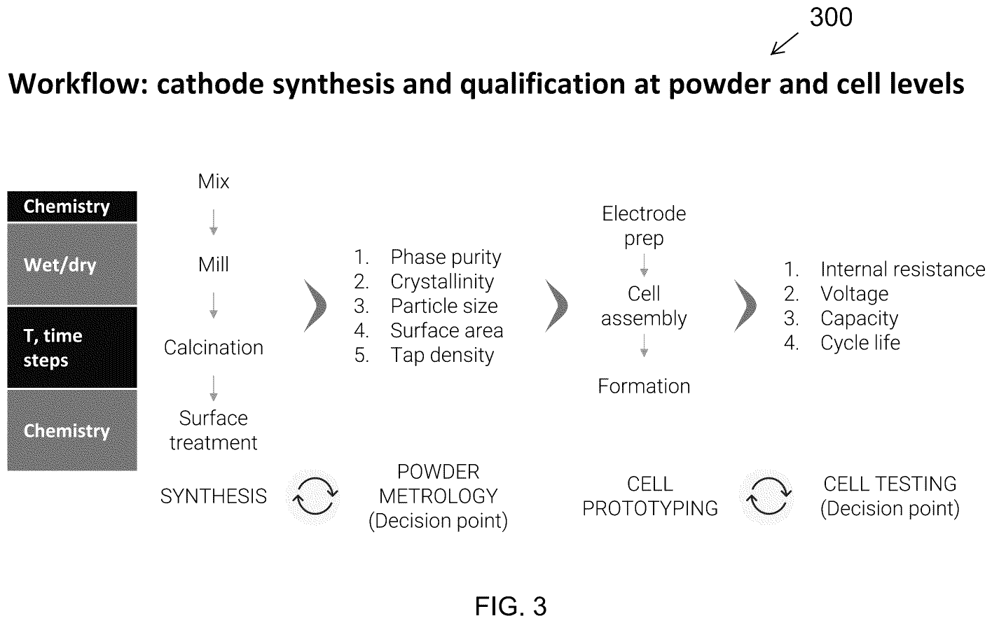

FIG. 3 is a workflow illustrating the steps for cathode synthesis and qualification at powder and cell levels according to an embodiment of the disclosure. As an example, workflow 300 is provided for forming a battery cell. Workflow or process 300 includes (1) synthesis, (2) powder metrology, (3) cell prototyping, and (4) cell testing.

Synthesis is the process of forming a cathode powder. As shown in FIG. 3, the synthesis includes mixing precursors, which relates to Li:Fe or Li:Mn or dopant stoichiometry chemistry. The synthesis also includes milling under wet or dry conditions. The synthesis also includes calcination under various temperatures and times. The synthesis further includes surface treatment, which also relates to chemistry.

The precursor materials (e.g., lithium salts, phosphates, silica) may then undergo chemical reactions in wet labs to synthesize a powder (e.g., LMX). One method for synthesizing the powder includes solid state synthesis. Solid state synthesis provides a continuous process that can be easily scaled for increased production. For solid state synthesis, the precursor materials do not react during the milling stage. Thus, the powder needs to be intermixed after milling.

The result of the milling process is a slurry in which the precursors may be milled down to a small size (e.g., sub-micron). Several different mills can be used to mill down the powder into a slurry. For example, a horizontal disc mill can be used to mill down the powder into sub-micron sizes. As another example, a planetary ball mill can be used to mill down the powder into a slurry. In some situations, a planetary ball mill may be preferable because the planetary ball mill can be configured to process multiple different compositions or powders in separate jars. In other words, the planetary ball mill may improve throughput by milling multiple different compositions simultaneously. One drawback of the planetary ball mill is that the planetary ball mill may need additional monitoring for temperature and gas, due to generation of undesired gas during milling.

In some situations, water may be used as a milling solvent. In other situations, alcohol or other milling solvents may be used when materials may not be compatible with water.

Other methods of synthesis (e.g., hydrothermal synthesis, solvothermal synthesis, microwave hydrothermal synthesis, etc.) can be complementary to solid state synthesis. These different methods of synthesis can reduce the need for milling due to dissolution of the materials in a solvent during the synthesis process. For example, hydrothermal synthesis can provide a more homogeneous powder. In hydrothermal synthesis, precursor materials are dissolved in a solvent (e.g., water or alcohol, etc.) to form a solution which is placed in an autoclave. The chamber is then sealed, heated to a high temperature (e.g., 200° C.), and pressurized at a high pressure (e.g., 300 Psi). Consequently, the reaction of the precursor materials take place in the solution under high heat and pressure inside a small chamber. After the reaction (e.g., after 24 hours), small crystals or small particles of a powder (e.g., LMX) remain. Hydrothermal synthesis is a slow batch process and is more difficult to scale. For example, typical hydrothermal synthesis can take up to a day to heat the materials and complete synthesis.

As another example, microwave hydrothermal and/or microwave solvothermal synthesis can utilize a microwave to quickly heat up the materials and complete the synthesis (e.g., 20 minutes). Microwave-assisted synthesis creates small batch sizes and is difficult to scale for increased production or throughput.

In some instances, these methods can include “one-pot” synthesis. One-pot synthesis can provide a convenient method of synthesis, in which all the raw materials are combined into one pot, in which the reaction occurs. Thus, the “one-pot” synthesis can provide a simplified process without additional precursor reactions, mixing, and other steps. One drawback for one-pot synthesis techniques is that these techniques are more difficult to control because it is possible that undesired reactions may occur without proper control or precautions.

For wet milling, after the powder is milled into a slurry, the slurry is dried, for example, by spray-drying. In some situations, the drying method may result in different characteristics of the resulting powder. For example, varying the nozzle, pressure, temperature, production chamber, etc. may result in different properties for the powder, such as shape, sphere sizes, etc. In some instances, nitrogen gas may be used to spray materials that may be sensitive to moisture. Another method for drying the materials utilizes a vacuum oven and/or a microwave oven.

After drying the cathode powder, the cathode powder is calcined by heating to an elevated temperature to remove volatile substances. Box furnaces and/or tube furnaces can be used to calcine the cathode powders. Calcination can include various configurable parameters, including temperatures, durations, layers of materials, stack heights, gases used in the furnaces, heating profiles, pressures, etc.

In some instances, the cathode powder may be treated to improve electrical conductivity. Carbon coating is a commonly employed technique for improving the conductivity of cathode active materials in lithium-ion batteries. Carbon coating can improve the electrical conductivity of the cathode active materials without changing other intrinsic properties. Uniform coating of carbon on cathode active materials or compounds helps avoid charge congregation and undesirable chemical reactions. The carbon coatings on cathode active materials or compounds (e.g., LMX), may affect the cycling performance of battery cells produced from the carbon coated cathode powders.

in some variations, the particles can be coated with a carbon coating. One way of forming the carbon coating is to put a soluble sugar (e.g., glucose) in the slurry, which is water-based. After spray drying, the sugar is present in the spray dried powder. During calcination, the sugar decomposes and forms a carbon coating around each particle.

The powder metrology includes performing material characterizations and analyses of the resulting synthesized powder to determine if a cathode powder is suitable for the next step, (e.g., cell prototyping or building a battery cell using the cathode powder). The material characterizations and analyses of the cathode powder are performed to determine one or more characteristics and/or properties of the cathode powder, such as phase purity, crystallinity, particle size, the surface area of a cathode particle, and tap density, among others. In some embodiments, the powder metrology can be performed automatically and the results of the powder metrology can be fed back into a machine learning model used to identify the precursor materials and process parameters for making the powder.

The phase purity, crystallinity, particle size, the surface area of the cathode particle can be determined by material analytical processes (e.g., facilitated by various analytical equipment), including X-ray diffraction analyses (XRD), scanning electron microscopy (SEM), energy-dispersive X-ray spectroscopy (EDS), among others.

For example, one tap density is one material property of interest. Tap density considers pores and voids between particles, which are not based on a loose powder bed but a bed after a defined number of tapping steps. The tap density of a cathode powder is determined after the defined tapping steps of the powder bed. The tap density is different from the bulk density of a powder, which considers the pores and voids of a loose powder bed. The bulk density can be determined if a powder is loosely poured into a measuring cylinder.

As further illustrated in FIG. 3, workflow 300 also includes cell prototyping, such as building a battery cell. Specifically, cell prototyping includes electrode preparation, cell assembly, and formation of a battery cell, such as a coin cell. After a cell prototype is formed, the cell can be tested (i.e., cell testing)to determine if the battery cell meets the target cell properties of the battery cell. Some target cell properties include internal resistance, voltage, capacity, and cycle life, among others.

For example, one target cell property is the capacity of a battery or battery cell, which is a measure of the charge stored by the battery and is determined by the mass of active material contained in the battery. The capacity represents the maximum amount of charge that can be extracted from the battery under certain specified conditions. The battery has a discharge current in the amperes that can be delivered over time. The capacity of the battery is given in ampere-hours (Ah).

viii. XRD Results

X-ray diffraction analyses (XRD) is an analytical technique used in materials sciences to determine some properties of a material, such as the crystal structure, chemical composition, and other physical properties. XRD is based on the constructive interference of monochromatic X-rays and a crystalline sample. X-rays are shorter wavelength electromagnetic radiations that are generated when electrically charged particles with sufficient energy are decelerated. In XRD, the generated X-rays are collimated (i.e., made parallel) and directed to a material sample, where the interaction of the incident rays with the sample produces a diffracted ray, which is then detected, processed, and counted. The intensity of the diffracted rays scattered at different angles of material is plotted to display a diffraction pattern.

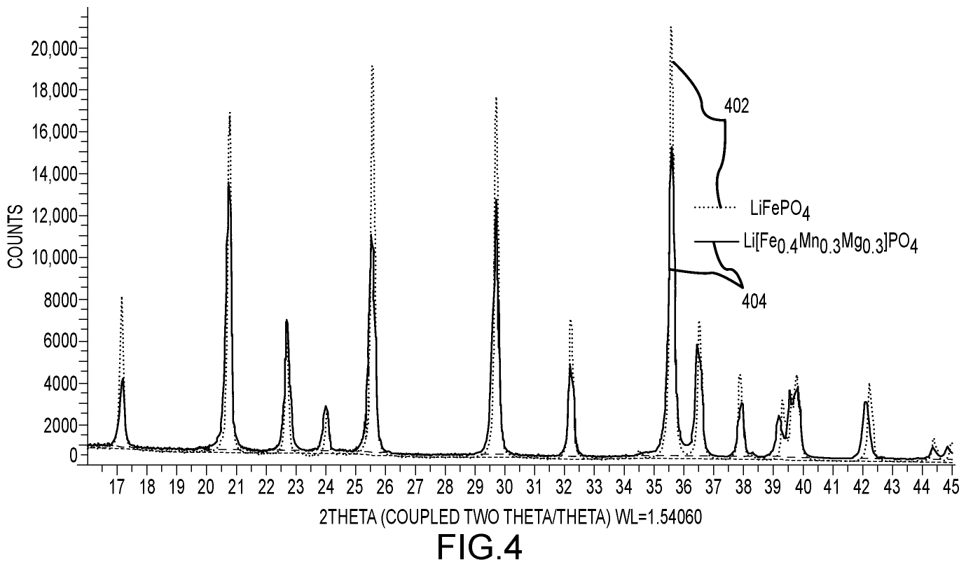

FIG. 4 illustrates X-ray diffraction (XRD) patterns of a LiFePO₄ compound and a Li[Fe_{0.4}Mn_{0.3}Mg_{0.3}]PO₄ compound according to some aspects of the disclosed technology. A horizontal axis or x-axis represents a two-theta angle while a vertical axis or y-axis represents arbitrary intensity or counts. The two-theta angle is used for the angle of detector position from the incident X-ray beam. As shown in FIG. 4, XRD pattern 402 represents the XRD result for LiFePO₄ compound while XRD pattern 404 represents the XRD result for Li[Fe_{0.4}Mn_{0.3}Mg_{0.3}]PO₄ compound.

FIG. 4 further illustrates that the XRD pattern 404 of Li[Fe_{0.4}Mn_{0.3}Mg_{0.3}]PO₄ compound superposes or overlaps with the XRD pattern 402 of LiFePO₄ compound, which indicates that Li[Fe_{0.4}Mn_{0.3}Mg_{0.3}]PO₄ compound has similar peaks as the LiFePO₄ compound. Thus, the XRD analysis demonstrates that Li[Fe_{0.4}Mn_{0.3}Mg_{0.3}]PO₄ compound has the same or a substantially similar structure as LiFePO₄. The XRD analysis also demonstrates that the Li[Fe_{0.4}Mn_{0.3}Mg_{0.3}]PO₄ compound has a single phase without any bi-product or impurities based on the XRD analysis.

ix. Cell Tests and Experimental Results

Cathode disks are formed from the synthesized powder. The density of the cathode disk is dependent on the size of the powder. More specifically, reducing the size of the powder can increase the density of the cathode disk. A mill is often used to grind the powder into a finer powder for such purposes.

Porosity is a measure of the void spaces in a material. The porosity of the cathode may affect the performance of an electrochemical cell. For example, cathode disks can be formed by compressing powder comprising the Li[Fe_{0.4}Mn_{0.3}Mg_{0.3}]PO₄ compound.

The cathode disks are assembled into button or coin cell batteries with an anode disk, and an electrolyte. As such, coin cells can be made with Li[Fe_{0.4}Mn_{0.3}Mg_{0.3}]PO₄ cathode disks. The coin cells are evaluated to determine various characteristics of the cathode material, including capacity, average voltage, volumetric energy density, and discharge energy retention. Cell experiments can include cycle tests performed on the coin cells. Galvanostatic charge/discharge cycling of the coin cells can be conducted.

The coin cells may be loaded into temperature-controlled chambers that may be connected to battery testers (e.g., fabricated by Neware or Arbin) and tested under customized testing protocols. The testing temperature may vary from about 10° C. to about 45° C. Various testing protocols can be designed to evaluate performance of coin cells, including varying testing currents (e.g., from C/100 to 1 C), varying voltage ranges (e.g., between about 1.5 V to about 5 V), varying number of cycles (from 1 cycle to 50 cycles), as well as various combinations of all above parameters. For example, the Galvanostatis charge/discharge cycling of the coin cells can be conducted with operation voltage ranging from 2.5 V to 5.2 V at a rate of C/10 under about 30° C.

An electrochemical tester provides a user with a variety of options in testing of batteries. Multiple channels can be plugged into the electrochemical tester to allow for multiple batteries to be tested simultaneously. These tests allow the user to fully understand the effectiveness of the electrochemical cell being tested by measuring parameters of the batteries, such as voltage, current, impedance, and capacity, among others. The tester can be attached to a computer to obtain digital testing values.

The following examples are for illustration purposes only. It will be apparent to those skilled in the art that many modifications, both to materials and methods, may be practiced without departing from the scope of the disclosure.

Experimental results of electrochemical analysis of a coin cell battery made from cathode material formed from the Li[Fe_{0.4}Mn_{0.3}Mg_{0.3}]PO₄ compound have demonstrated a potential of high GED.

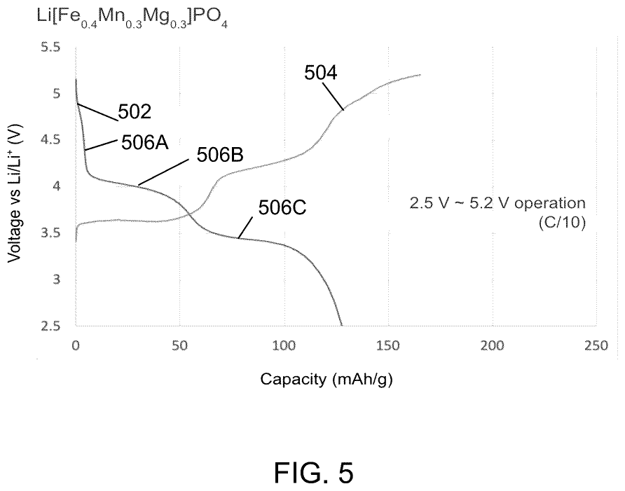

FIG. 5 illustrates charging and discharging data of Li[Fe_{0.4}Mn_{0.3}Mg_{0.3}]PO₄ compound according to some aspects of the disclosed technology. A horizontal or x-axis represents the specific capacity of the battery and a vertical or y-axis represents the voltage of the battery versus Li metal. The operation voltage ranges from 2.5 V to 5.2 V versus Li. The voltage versus Li metal means that the reference voltage of cathode voltage is the voltage of Li metal.

As shown in FIG. 5, curve 502 represents discharging while curve 504 represents charging. Curve 502 includes three different regions 506A, 506B, and 506C during the discharging. First, second and third regions 506A, 506B, 506C indicate three different reductions, including the reduction of Mn⁴⁺ to Mn³⁺, the reduction of Mn³⁺ to Mn²⁺, and the reduction of Fe³⁺ to Fe²⁺, respectively.

At the beginning of discharging as demonstrated by the first region 506A (e.g., 0 to 10 mAh/g region), the potential energy drops from approximately 5 V to approximately 4.2 V, which is indicative of the reduction of Mn⁴⁺ to Mn³⁺ in the Li[Fe_{0.4}Mn_{0.3}Mg_{0.3}]PO₄ compound, which is also referred to as the Mn^{3+/4+} reduction. The reduction potential is about 4.8 V versus Li.

After the Mn^{3+/4+} reduction, the second region 506B (e.g., 10 to 60 mAh/g region) is indicative of the reduction of Mn³⁺ to Mn²⁺, which is also referred to as the Mn^{2+/3+} reduction. The third region 506C (e.g., 60 to 130 mAh/g region) is indicative of the reduction of Fe³⁺to Fe²⁺, which is also referred to as the Fe^{2+/3+} reduction.

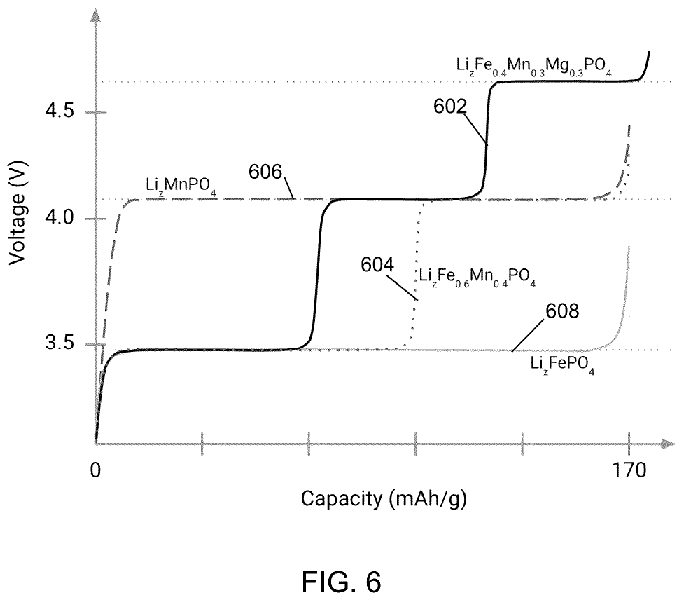

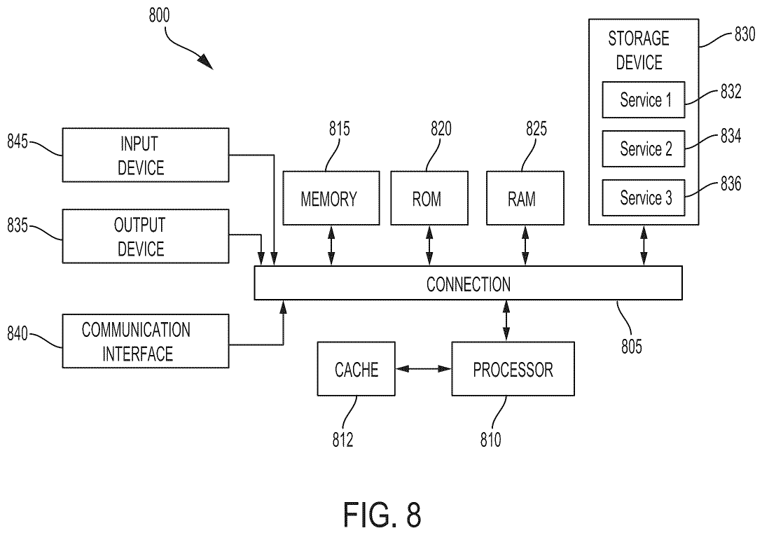

FIG. 6 illustrates comparisons of voltage versus capacity during charging or discharging for Li[Fe_{0.4}Mn_{0.3}Mg_{0.3}]PO₄, LiFe_{0.6}Mn_{0.4}PO₄, LiMnPO₄, and LiFePO₄ compounds according to some aspects of the disclosed technology. As shown, charging or discharging curves 602, 604, 606, and 608 represent discharge voltage versus capacity during charging for compounds Li_{z}[Fe_{0.4}Mn_{0.3}Mg_{0.3}]PO₄, Li_{z}Fe_{0.6}Mn_{0.4}PO₄, Li_{z}MnPO₄, and Li_{z}FePO₄, respectively, where the subscript z is the variable during charging. At the beginning of charging when capacity is zero, z=1, while at the end of charging when the capacity reaches the highest value, such as 170 mAh/g, z=0, the Li[Fe_{0.4}Mn_{0.3}Mg_{0.3}]PO₄ reaches the highest voltage of above 4.5 V among the four compounds at the end of charging. At the end of charging, LiFe_{0.6}Mn_{0.4}PO₄ and LiMnPO₄, compounds can have a voltage of about 4.1 V, which is higher than that of LiFePO₄ having a voltage of about 3.5 V. GED can be calculated by the area under the charging or discharging curve, such as curves 602, 604, 606, and 608 in FIG. 6, which is voltage multiplied by capacity. Accordingly, the areas under curves 602, 604, 606, and 608 are indicative of the GED of each compound. Therefore, Li[Fe_{0.4}Mn_{0.3}Mg_{0.3}]PO₄ has the largest area under their respective curve 602 among the four compounds or the highest GED among the four compounds.

x. Neural Network Architecture and Machine Learning

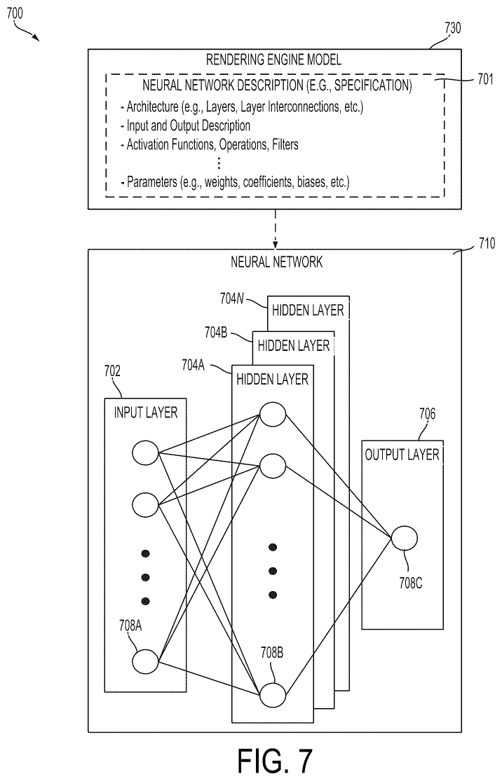

FIG. 7 illustrates an example neural network architecture, in accordance with some aspects of the present technology. Architecture 700 includes a neural network 710 defined by an example neural network description 701 in rendering engine model (neural controller) 330.The neural network 710 can represent a neural network implementation of a rendering engine for rendering media data. The neural network description 701 can include a full specification of the neural network 710, including the neural network architecture 700.For example, the neural network description 701 can include a description or specification of the architecture 700 of the neural network 710 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 710 reflects the architecture 700 defined in the neural network description 701. In this example, the neural network 710 includes an input layer 702, which includes input data, such as powder information and coin cell electrochemical data. In one illustrative example, the input layer 702 can include seed data including coin cell electrochemical data.

The neural network 710 includes hidden layers 704A through 704N (collectively “704” hereinafter). The hidden layers 704 can include n number of hidden layers, where n is an integer greater than or equal to one. The number of hidden layers can include as many layers as needed for the desired processing outcome and/or rendering intent. The neural network 710 further includes an output layer 706 that provides an output (e.g., the variables in the design space to result in coin cells with the coin cell energy density or gravimetric energy density (GED), tap density, or volume energy density (VED), among others) resulting from the processing performed by the hidden layers 704. In one illustrative example, the output layer 706 can provide parameters for the variables in the design space that can increase the coin cell energy density, GED, tap density, or VED.

The neural network 710 in this example is a multi-layer neural network of interconnected nodes. Each node can represent a piece of information. Information associated with the nodes is shared among the different layers and each layer retains information as information is processed. In some cases, the neural network 710 can include a feed-forward neural network, in which case there are no feedback connections where outputs of the neural network are fed back into itself. In other cases, the neural network 710 can include a recurrent neural network, which can have loops that allow information to be carried across nodes while reading in input.

Information can be exchanged between nodes through node-to-node interconnections between the various layers. Nodes of the input layer 702 can activate a set of nodes in the first hidden layer 704A. For example, as shown, each of the input nodes of the input layer 702 is connected to each of the nodes of the first hidden layer 704A. The nodes of the hidden layer 704A can transform the information of each input node by applying activation functions to the information. The information derived from the transformation can then be passed to and can activate the nodes of the next hidden layer (e.g., 704B), which can perform their own designated functions. Example functions include convolutional, up-sampling, data transformation, pooling, and/or any other suitable functions. The output of the hidden layer (e.g., 704B) can then activate nodes of the next hidden layer (e.g., 704N), and so on. The output of the last hidden layer can activate one or more nodes of the output layer 706, at which point output is provided. In some cases, while nodes (e.g., nodes 708A, 708B, 708C) in the neural network 710 are shown as having multiple output lines, a node has a single output and all lines are shown as being output from a node represent the same output value.

In some cases, each node or interconnection between nodes can have a weight that is a set of parameters derived from training the neural network 710. Once the neural network 700 is trained, it can be referred to as a trained neural network, or trained machine learning algorithm which can be used to classify one or more activities. For example, an interconnection between nodes can represent a piece of information learned about the interconnected nodes. The interconnection can have a numeric weight that can be tuned (e.g., based on a training dataset), allowing the neural network 710 to be adaptive to inputs and able to learn as more data is processed.

The neural network 710 can be pre-trained to process the features from the data in the input layer 702 using the different hidden layers 704 to provide the output through the output layer 706. In an example in which the neural network 710 is used to identify an object collision path from a trained object path prediction algorithm, the neural network 710 can be trained using training data that includes seed data obtained from experiments, such as coin cell electrochemical data, or powder information, where the powder was synthesized from experiments. For instance, training seed data can be input into the neural network 710, which can be processed by the neural network 710 to generate outputs that can be used to tune one or more aspects of the neural network 710, such as weights, biases, etc.

In some cases, the neural network 710 can adjust the weights of nodes using a training process called backpropagation. Backpropagation can include a forward pass, a loss function, a backward pass, and a weight update. The forward pass, loss function, backward pass, and parameter update are performed for one training iteration. The process can be repeated for a certain number of iterations for each set of training media data until the weights of the layers are accurately tuned. For a first training iteration for the neural network 710, the output can include values that do not give preference to any particular class due to the weights being randomly selected at initialization. For example, if the output is a vector with probabilities that the object includes the different product(s) and/or different users, the probability value for each of the different products and/or users may be equal or at least very similar (e.g., for ten possible products or users, each class may have a probability value of 0.1). With the initial weights, the neural network 710 is unable to determine low-level features and thus cannot make an accurate determination of what the classification of the object might be. A loss function can be used to analyze errors in the output. Any suitable loss function definition can be used. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) can be high for the first training dataset (e.g., images) since the actual values will be different than the predicted output. The goal of training is to minimize the amount of loss so that the predicted output comports with a target or ideal output. The neural network 710 can perform a backward pass by determining which inputs (weights) most contributed to the loss of the neural network 710, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=w_i−ρ dL/dW, where w denotes a weight, wi denotes the initial weight, and ρ denotes a learning rate. The learning rate can be set to any suitable value, with a high learning rate including larger weight updates and a lower value indicating smaller weight updates.

The neural network 710 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 710 can represent any other neural or deep learning network, such as an autoencoder, deep belief nets (DBNs), recurrent neural networks (RNNs), etc.

As understood by those of skill in the art, machine-learning-based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; generative adversarial networks (GANs); support vector machines; image registration methods; applicable rule-based system. Where regression algorithms are used, they may include but are not limited to: a Stochastic Gradient Descent Regressor, and/or Passive-Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

FIG. 8 illustrates an example processor-based system with which some aspects of the subject technology can be implemented. For example, the processor-based system 800 can be any computing device making up, or any component thereof in which the components of the system are in communication with each other using connection 805. Connection 805 can be a physical connection via a bus, or a direct connection into processor 810, such as in a chipset architecture. Connection 805 can also be a virtual, networked connection, or logical connection.

In some embodiments, computing system 800 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

The example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810.Computing system 800 can include a cache of high-speed memory 812 connected directly with, close to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may be a self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (W1MAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine the location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., and when the code that defines such software is executed by the processor 810, it causes the system 800 to perform a function. In some embodiments, a hardware service that performs a particular function can include the software component stored in a computer-readable medium in connection with the hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general-purpose or special-purpose computer, including the functional design of any special-purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or a combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or a combination thereof) through a communications network. In a distributed computing environment, program modules may be located in both local and remote memory storage devices.

It will be understood that the cathode materials or cathode active materials described herein can be used in conjunction with any battery cells or components thereof known in the art. For example, in addition to wound battery cells, the layers may be stacked and/or used to form other types of battery cell structures, such as bi-cell structures. All such battery cell structures are known in the art.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

Aspect 1. A powder comprising a lithium metal polyanion (LMX) compound represented by Formula (I) Li(LiₓTM_{y}TM′_{(1-x-y)})(P,A)O₄, Formula (I) wherein 0.1≤x, 0≤y<1, and Li/(TM′+TM)>1, wherein TM is one or more elements selected from Mn, Mg, Zn, Ca, Ni, Co, V, Al, Ti, Zr, Mo, Cr, or other transition metal, wherein TM′ is a combination of Fe and Mn transition metal.

Aspect 2. The powder of aspect 1, wherein at least one process variable or at least one stoichiometry variable required to produce the compound represented in Formula (I) is provided by a machine learning algorithm.

Aspect 3. The powder of aspect 1, wherein TM is Mo, the compound is represented by Li[Li]_{0.2}Fe_{0.2}Mn_{0.5}Ti_{0.1}PO₄.

Aspect 4. The powder of aspect 1, wherein TM is V, the compound is represented by Li[Li]_{0.1}Fe_{0.8}V_{0.1}PO₄.

Aspect 5. The powder of aspect 1, wherein the compound is represented by Li[Li]_{0.1}Mn_{0.6}Mg_{0.2}V_{0.1}PO₄.

Aspect 6. A cathode active material comprising the powder of aspect 1.

Aspect 7. A cathode comprising the cathode active material of aspect 6.

Aspect 8. A battery cell comprising a cathode of aspect 7; a separator; and an anode, wherein the battery cell comprises a gravimetric capacity exceeding 170 mAh/g.

Aspect 9. A powder comprising a lithium manganese phosphate compound represented by Formula (II): Li[Fe_{1-x-y}MnₓTM_{y}](P,A)O₄ Formula (II) wherein 0.15<x<0.45, 0.20<y<0.45, wherein TM is at least one element selected from Mn, Mg, Zn, Ca, Ni, Co, V, Al, Ti, Zr, Mo, and Cr.

Aspect 10.The powder of aspect 9, wherein x=0.3, y=0.3, TM=Mg, the compound is represented by Li[Fe_{0.4}Mn_{0.3}Mg_{0.3}]PO₄.

Aspect 11. The powder of aspect 10, wherein Li[Fe_{1-x-y}MnₓMg_{y}]PO₄ has a structure same as LiFePO₄ based on X-ray diffraction (XRD) analysis.

Aspect 12. The powder of aspect 9, wherein A represents one of V, Si, or W.

Aspect 13. A cathode active material comprising the powder of aspect 9.

Aspect 14. A cathode comprising the cathode active material of aspect 13.

Aspect 15. A battery cell comprising a cathode of aspect 14; a separator; and an anode, wherein the battery cell comprises a gravimetric capacity exceeding 170 mAh/g.

Aspect 16. A method of designing the LMX compound of aspect 1, the method comprising optimizing composition of the LMX compound to achieve a gravimetric capacity exceeding 170 mAh/g using a machine learning (ML) assisted design combined with an experiment approach.

Aspect 17. The method of aspect 16, the method further comprising: synthesizing the compound to form the powder of claim 1; evaluating the powder and the battery cell of claim 8 for an electrochemical performance; using the electrochemical performance and powder information to train a Machine Learning model; fitting a Gaussian process model using energy density of the battery cell as output, subject to constraints of powder level metrics falling within a set of specifications; using an acquisition function to determine N variations to evaluate in a next iteration, that are likely to maximize the energy density; synthesizing the N variations; evaluating the powder and the electrochemical performance of the battery cell; and repeating the experiments and training ML model until a difference in successive iterations falls below a threshold.

Aspect 18. A method of designing the LMX compound of aspect 9, the method comprising optimizing composition of the LMX compound to achieve a gravimetric capacity exceeding 170 mAh/g using a machine learning (ML) assisted design combined with an experiment approach.

Aspect 19. The method of aspect 18, the method further comprising: synthesizing the compound to form the powder of claim 9; evaluating the powder and the battery cell of claim 15 for an electrochemical performance; using the electrochemical performance and powder information to train a Machine Learning model; fitting a Gaussian process model using energy density of the battery cell as output, subject to constraints of powder level metrics falling within a set of specifications; using an acquisition function to determine N variations to evaluate in a next iteration, that are likely to maximize the energy density; synthesizing the N variations; evaluating the powder and the electrochemical performance of the battery cell; and repeating the experiments and training ML model until a difference in successive iterations falls below a threshold.

What is claimed:

1. A powder comprising a lithium metal polyanion (LMX) compound represented by Formula (I)
Li(LiₓTM_{y}TM′_{(1-x-y)})(P,A)O₄ Formula (I)
wherein 0.1≤x, 0≤y<1, and Li/(TM′+TM)>1, wherein TM is one or more elements selected from Mn, Mg, Zn, Ca, Ni, Co, V, Al, Ti, Zr, Mo, Cr, or other transition metal, wherein TM′ is a combination of Fe and Mn transition metal.

2. The powder of claim 1, wherein at least one process variable or at least one stoichiometry variable required to produce the compound represented in Formula (I) is provided by a machine learning algorithm.

3. The powder of claim 1, wherein TM is Mo, the compound is represented by Li[Li]_{0.2}Fe_{0.2}Mn_{0.5}Ti_{0.1}PO₄.

4. The powder of claim 1, wherein TM is V, the compound is represented by Li[Li]_{0.1}Fe_{0.8}V_{0.1}PO₄.

5. The powder of claim 1, wherein the compound is represented by Li[Li]_{0.1}Mn_{0.6}Mg_{0.2}V_{0.1}PO₄.

6. A cathode active material comprising the powder of claim 1.

7. A cathode comprising the cathode active material of claim 6.

8. A battery cell comprising
a cathode of claim 7;
a separator; and
an anode, wherein the battery cell comprises a gravimetric capacity exceeding 170 mAh/g.

9. A powder comprising a lithium manganese phosphate compound represented by Formula (II):
Li[Fe_{1-x-y}MnₓTM_{y}](P,A)O₄ Formula (II)
wherein 0.15<x<0.45, 0.20<y<0.45, wherein TM is at least one element selected from Mn, Mg, Zn, Ca, Ni, Co, V, Al, Ti, Zr, Mo, and Cr.

10. The powder of claim 9, wherein x=0.3, y=0.3, TM=Mg, the compound is represented by Li[Fe_{0.4}Mn_{0.3}Mg_{0.3}]PO₄.

11. The powder of claim 10, wherein Li[Fe_{1-x-y}MnₓMg_{y}]PO₄ has a structure same as LiFePO₄ based on X-ray diffraction (XRD) analysis.

12. The powder of claim 9, wherein A represents one of V, Si, or W.

13. A cathode active material comprising the powder of claim 9.

14. A cathode comprising the cathode active material of claim 13.

15. A battery cell comprising
a cathode of claim 14;
a separator; and
an anode, wherein the battery cell comprises a gravimetric capacity exceeding 170 mAh/g.

16. A method of designing the LMX compound of claim 1, the method comprising optimizing composition of the LMX compound to achieve a gravimetric capacity exceeding 170 mAh/g using a machine learning (ML) assisted design combined with an experiment approach.

17. The method of claim 16, the method further comprising:
synthesizing the compound to form the powder of claim 1;
evaluating the powder and the battery cell of claim 8 for an electrochemical performance;
using the electrochemical performance and powder information to train a Machine Learning model;
fitting a Gaussian process model using energy density of the battery cell as output, subject to constraints of powder level metrics falling within a set of specifications;
using an acquisition function to determine N variations to evaluate in a next iteration, that are likely to maximize the energy density;
synthesizing the N variations;
evaluating the powder and the electrochemical performance of the battery cell; and
repeating the experiments and training ML model until a difference in successive iterations falls below a threshold.

18. A method of designing the LMX compound of claim 9, the method comprising optimizing composition of the LMX compound to achieve a gravimetric capacity exceeding 170 mAh/g using a machine learning (ML) assisted design combined with an experiment approach.

19. The method of claim 18, the method further comprising:
synthesizing the compound to form the powder of claim 9;
evaluating the powder and the battery cell of claim 15 for an electrochemical performance;
using the electrochemical performance and powder information to train a Machine Learning model;
fitting a Gaussian process model using energy density of the battery cell as output, subject to constraints of powder level metrics falling within a set of specifications;
using an acquisition function to determine N variations to evaluate in a next iteration, that are likely to maximize the energy density;
synthesizing the N variations;
evaluating the powder and the electrochemical performance of the battery cell; and
repeating the experiments and training ML model until a difference in successive iterations falls below a threshold.
